(19) United States
(12) Patent Application Publication
(10) Pub. No.: US 2014/0076198 A1
(43) Pub. Date: Mar. 20, 2014

(54) EPOXY RESIN COMPOSITION FOR INSULATION, INSULATING FILM, PREPREG, AND PRINTED CIRCUIT BOARD

(71) Applicant: SAMSUNG ELECTRO-MECHANICS CO., LTD., Suwon (KR)

(72) Inventors: Jin Young Kim, Suwon (KR); Sa Yong Lee, Suwon (KR); Geum Hee Yun, Suwon (KR); Keun Yong Lee, Suwon (KR)

(73) Assignee: SAMSUNG ELECTRO-MECHANICS CO., LTD., Suwon (KR)

(21) Appl. No.: 13/735,741

(22) Filed: Jan. 7, 2013

(30) Foreign Application Priority Data
Sep. 19, 2012 (KR) 10-2012-0104043

(51) Int. Cl. C09D 163/00

(52) U.S. Cl. CPC C09D 163/00
USPC 106/241; 524/27

(57) ABSTRACT

Disclosed herein are an epoxy resin composition for insulation, and an insulating film, a prepreg, and a printed circuit board, manufactured using the same, the epoxy resin composition including: a chitin nanoparticle or a chitin nanofiber; a liquid crystal oligomer or a soluble liquid crystal thermosetting oligomer; an epoxy resin; and an inorganic filler, so that the epoxy resin composition, the insulating film, and the prepreg can have a low coefficient of thermal expansion, a high glass transition temperature, and high rigidity.

### CROSS REFERENCE TO RELATED APPLICATION

This application claims the benefit of Korean Patent Application No. 10-2012-0104043, filed on Sep. 19, 2012, entitled “Epoxy Resin Composition for Insulation, Insulating Film, Prepreg, and Printed Circuit Board”, which is hereby incorporated by reference in its entirety into this application.

### BACKGROUND OF THE INVENTION

1. Technical Field

The present invention relates to an epoxy resin composition for insulation, an insulating film, a prepreg, and a printed circuit board.

2. Description of the Related Art

With the development of electronic devices and request for complicated functions, a printed circuit board has continuously been requested to have a low weight, a thin thickness, and a small size. In order to satisfy these requests, wirings of the printed circuit board becomes more complex, further densified, and higher functioned.

As such, as the electronic device has a smaller size and a higher function, a multilayer printed circuit board is requested to become further densified, higher functioned, smaller, and thinner. Particularly, the multilayer printed circuit board has been developed to have finer and higher densified wirings. For this reason, thermal, mechanical, and electrical properties become important in an insulating layer of the multilayer printed circuit board. In order to minimize warpage occurring due to reflow in a procedure of mounting electronic and electric devices, a low coefficient of thermal expansion (CTE), a high glass transition temperature (Tg), and a high modulus are required.

Meanwhile, various methods have been studied to improve mechanical, electric, and thermal properties of the insulating layer in the multilayer printed circuit board used in electronic devices according to the development thereof. For example, in order to enhance adhesive strength and realize a low coefficient of thermal expansion and high strength (modulus) of insulating materials for a printed circuit board, the insulating materials are manufactured by filling a ceramic filler such as silica, alumina, or the like, in a resin layer such as an epoxy resin, polyimide, aromatic polyester, or the like, but sufficient results are not obtained. In addition, Patent Document 1 discloses that a thermosetting resin composition containing a cellulose derivative and a thermosetting compound is excellent in adhesion with a substrate, flexure resistance, low flexibility, soldering heat resistance, electric insulation, and the like. However, requisitions for the printed circuit board having more complicated, further densified, and higher functioned wirings are still not satisfied.
Patent Document 1 Japanese Patent Laid-Open Publication No. 2009-235171

### SUMMARY OF THE INVENTION

The present inventors confirmed that products manufactured by using an epoxy resin composition including a chitin nanoparticle or a chitin nanofiber, a liquid crystal oligomer (LCO) or a soluble liquid crystal thermosetting oligomer (LCTO), and an epoxy resin had relatively a low coefficient of thermal expansion (CTE), a high glass transition temperature (Tg), and a high modulus, for allowing minimization of warpage thereof, and then the present invention was completed based on this.

The present invention has been made in an effort to provide an epoxy resin composition for insulation, having excellent thermal, mechanical, and electrical properties.

Also, the present invention has been made in an effort to provide an insulating film having improved thermal, mechanical, and electrical properties, which is manufactured by using the epoxy resin composition.

Also, the present invention has been made in an effort to provide a prepreg having improved thermal, mechanical, and electrical properties by impregnating a substrate with the epoxy resin composition.

Also, the present invention has been made in an effort to provide a printed circuit board, preferably a multilayer printed circuit board, including the insulating film or the prepreg.

According to a preferred embodiment of the present invention, there is provided an epoxy resin composition for insulation, the epoxy resin composition including: a chitin nanoparticle or a chitin nanofiber; a liquid crystal oligomer or a soluble liquid crystal thermosetting oligomer; an epoxy resin; and an inorganic filler.

The liquid crystal oligomer or the soluble liquid crystal thermosetting oligomer may be represented by Chemical Formula 1, 2, 3, or 4, below:

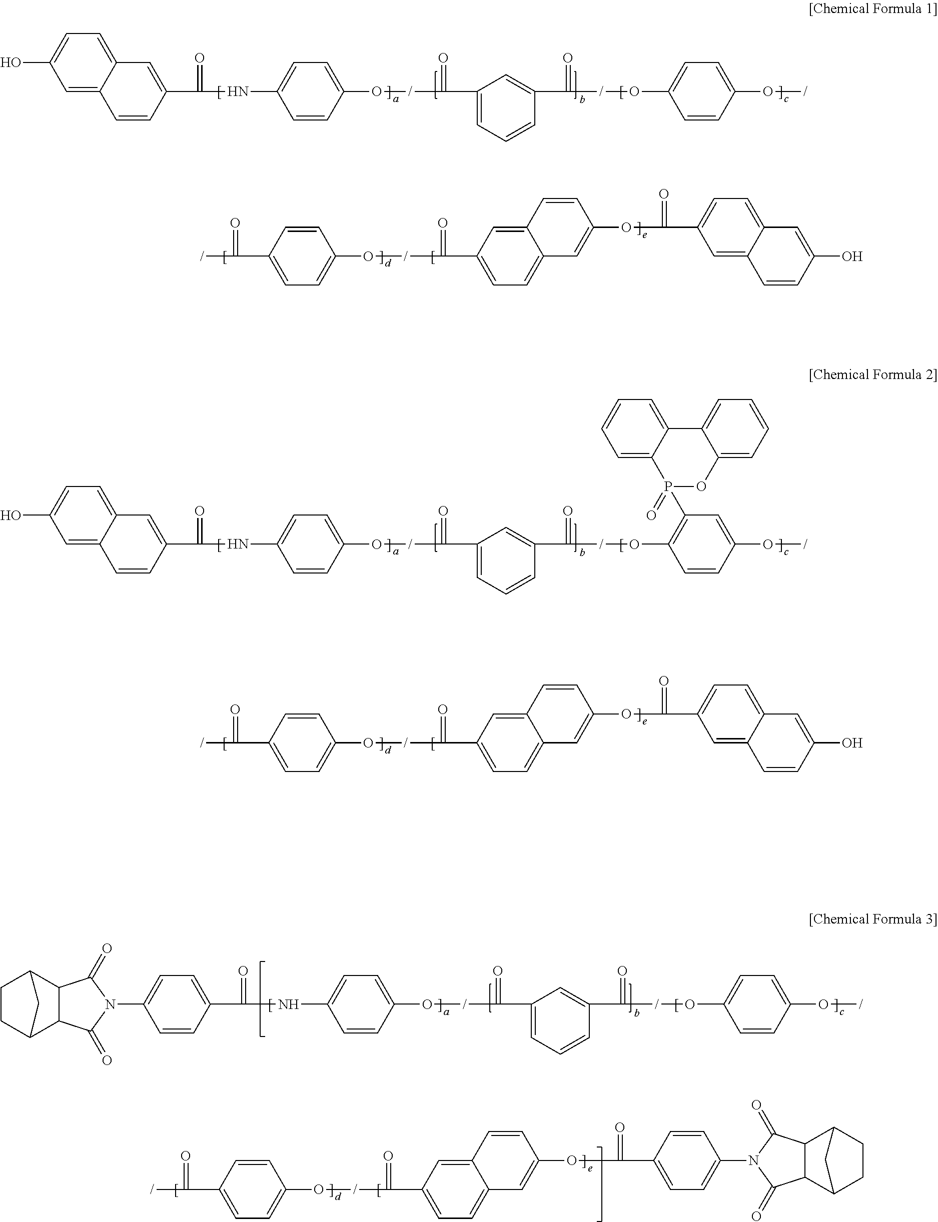

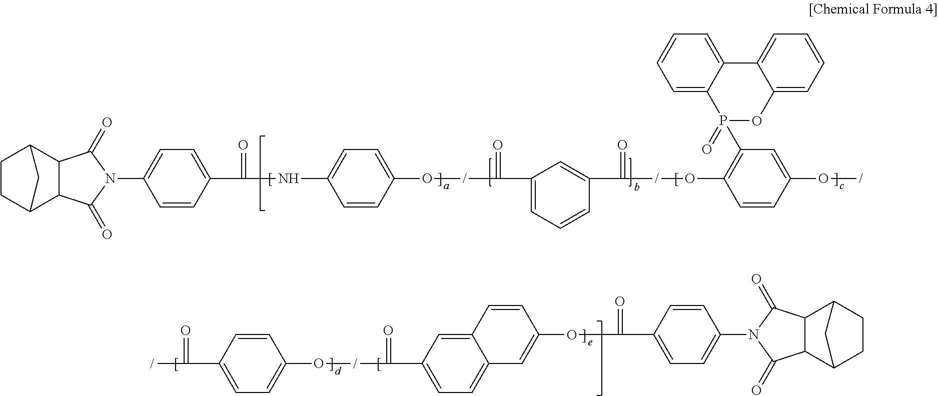

wherein in Chemical Formulas 1 to 4, a is an integer of 13˜26, b is an integer of 13˜26, c is an integer of 9˜21, d is an integer of 10˜30, and e is an integer of 10˜30.

The epoxy resin may be represented by Chemical Formula 5 or 6:

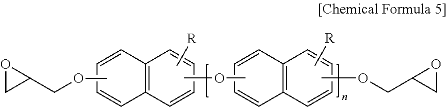

wherein in Chemical Formula 5, R is C1˜C20 alkyl, and n is an integer of 0˜20,

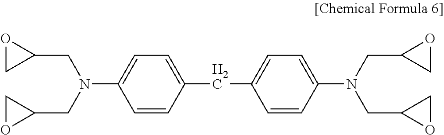 [SMILES: c1cc(N(CC2CO2)CC2CO2)ccc1Cc1ccc(N(CC2CO2)CC2CO2)cc1]

The epoxy resin composition may contain 0.5 to 30 wt. % of the chitin nanoparticle or the chitin nanofiber, 5 to 60 wt. % of the liquid crystal oligomer, 5 to 50 wt. % of the epoxy resin, and 30 to 80 wt. % of the inorganic filler.

The liquid crystal oligomer or the soluble liquid crystal thermosetting oligomer may have a number average molecular weight of 2,500 to 6,500.

The epoxy resin composition may further include at least one epoxy resin selected from a naphthalene based epoxy resin, a bisphenol A type epoxy resin, a phenol novolac epoxy resin, a cresole novolac epoxy resin, a rubber modified epoxy resin, and a phosphorous based epoxy resin.

The epoxy resin composition may further include at least one hardener selected from amide based hardeners, polyamine based hardeners, acid anhydride hardeners, phenol novolac type hardeners, polymercaptan hardeners, tertiary amine hardeners, and imidazole hardeners.

The inorganic filler may be at least one selected from the group consisting of silica, alumina, barium sulfate, talc, mud, a mica powder, aluminum hydroxide, magnesium hydroxide, calcium carbonate, magnesium carbonate, magnesium oxide, boron nitride, aluminum borate, barium titanate, calcium titanate, magnesium titanate, bismuth titanate, titan oxide, barium zirconate, and calcium zirconate.

The inorganic filler may have a diameter of 0.008 to 10 μm.

The epoxy resin composition may further include at least one hardening accelerator selected from metal based hardening accelerators, imidazole based hardening accelerators, and amine based hardening accelerators.

The epoxy resin composition may further include at least one thermoplastic resin selected from a phenoxy resin, a polyimide resin, a polyamideimide (PAI) resin, a polyetherimide (PEI) resin, a polysulfone (PS) resin, a polyethersulfone (PES) resin, a polyphenyleneether (PPE) resin, a polycarbonate (PC) resin, a polyetheretherketone (PEEK) resin, and a polyester resin.

According to another preferred embodiment of the present invention, there is provided an insulating film manufactured by using the epoxy resin composition as described above.

According to still another preferred embodiment of the present invention, there is provided a prepreg manufactured by impregnating a substrate with the epoxy resin composition as described above.

According to still another preferred embodiment of the present invention, there is provided a printed circuit board including the insulating film as described above.

According to still another preferred embodiment of the present invention, there is provided a printed circuit board including the prepreg as described above.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a cross-sectional view of a copper clad laminate where copper foil is formed on a prepreg formed of an epoxy resin composition according to the present invention; and

FIG. 2 is a cross-sectional view of a general printed circuit board to which the epoxy resin composition according to the present invention is applicable.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

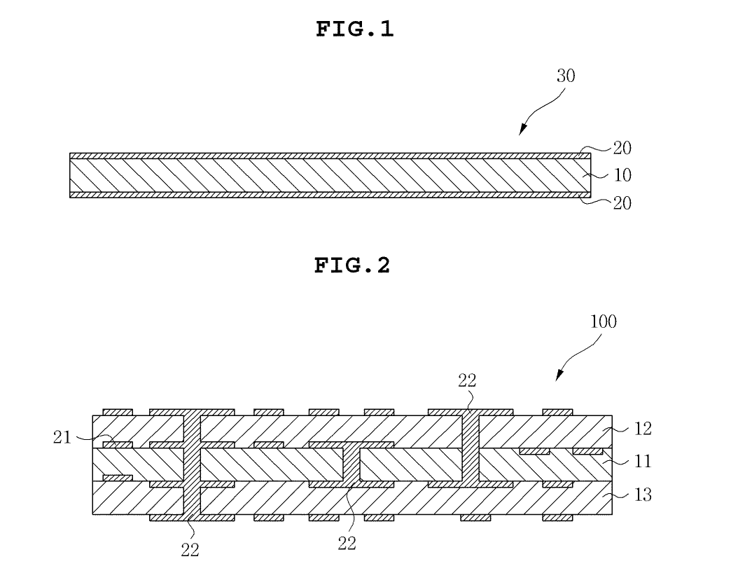

Referring to FIGS. 1 and 2, a printed circuit board according to a preferred embodiment of the present invention may include, by using a copper clad laminate 30 where copper foil 20 is formed on a prepreg 10 formed of an epoxy resin composition according to the present invention, an insulator 11 having a cavity, for example, an insulating film or a prepreg, and another insulator 12 or 13 disposed on at least one of an upper surface and a lower surface of the insulator 11, for example, a buildup layer. The buildup layer may include circuit layers 21 and 22 formed on the insulator 12 and the insulator 13 disposed on at least one of the upper surface and the lower surface of the insulator 11, to allow interlayer connection. Here, the insulators 10, 11, 12, and 13 may serve to give insulation between the circuit layers or between electronic components, and also serve as a structural member for maintaining rigidity of a package.

Here, in order to minimize warpage of a printed circuit board 100, preferably, a multilayer printed circuit board, which is caused by a reflow process, in the process of mounting electronic and electric devices on the printed circuit board, the insulators 10, 11, 12, and 13 of the present invention are required to have thermal, mechanical, and electrical properties, such as, a low coefficient of thermal expansion, a high glass transition temperature, and a high modulus. In addition, the insulators 10, 11, 12, and 13 according to the present invention may make low roughness for forming fine circuit patterns while fundamentally securing low dielectric constant and hygroscopicity.

As such, in the present invention, the insulators 10, 11, 12, and 13 are manufactured by using an epoxy resin composition including a chitin nanoparticle or a chitin nanofiber; a liquid crystal oligomer (LCO) or a soluble liquid crystal thermosetting oligomer (LCTO); an epoxy resin; and an inorganic filler, in order to secure excellent thermal, mechanical, and electrical properties thereof. Optionally, the epoxy resin composition according to the present invention may further include a hardener, a hardening accelerator, another epoxy resin, and/or other additives.

Chitin Nanoparticle or Chitin Nanofiber

As shown in Chemical Formula 7 below, when many hydroxy groups and acetylamino-2-deoxy groups on a surface of a chitin nanoparticle or a chitin nanofiber react with an epoxy group to induce a cross-linkage reaction and react with an amine group of a backbone of the liquid crystal oligomer, to thereby conducting a hardening reaction, strength of the resin is enhanced and hardening density is improved, resulting in a low coefficient of thermal expansion (CTE). Particularly, the number of hydrogen bonds which may be formed at acetyl amine groups of chitin is increased, strength of the resin can be significantly enhanced. As such, together with enhancement in strength of the resin, the printed circuit board also can be enhanced.

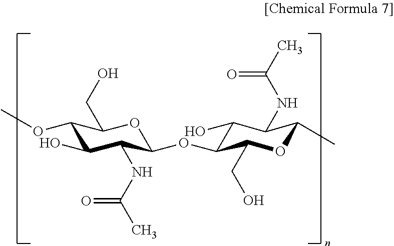

Chitin is a polymer polysaccharide where N-acetyl glucosamine monomers are combined in a long chain type. Generally, the chitin nanoparticle may be prepared through acid hydrolysis and physical dispersion. In the present invention, a method for preparing the chitin nanoparticle is not particularly limited, and all chitin nanoparticles prepared by methods known to those skilled in the art may be used.

In the present invention, the content of the chitin nanoparticle or the chitin nanofiber is 0.5 to 30 wt. %. If the content thereof is below 0.5 wt. %, addition thereof is almost never effective. If the content thereof is above 30 wt. %, the total solid content is high, and thus it is difficult to form an insulating film, or molding of the member is difficult even though the insulating film is formed.

Liquid Crystal Oligomer or Soluble Liquid Crystal Thermosetting Oligomer

The liquid crystal oligomer or soluble liquid crystal thermosetting oligomer used in the present invention (hereinafter, “liquid crystal oligomer) may be a compound represented by Chemical Formula 1, Chemical Formula 2, Chemical Formula 3, or Chemical Formula 4, below.

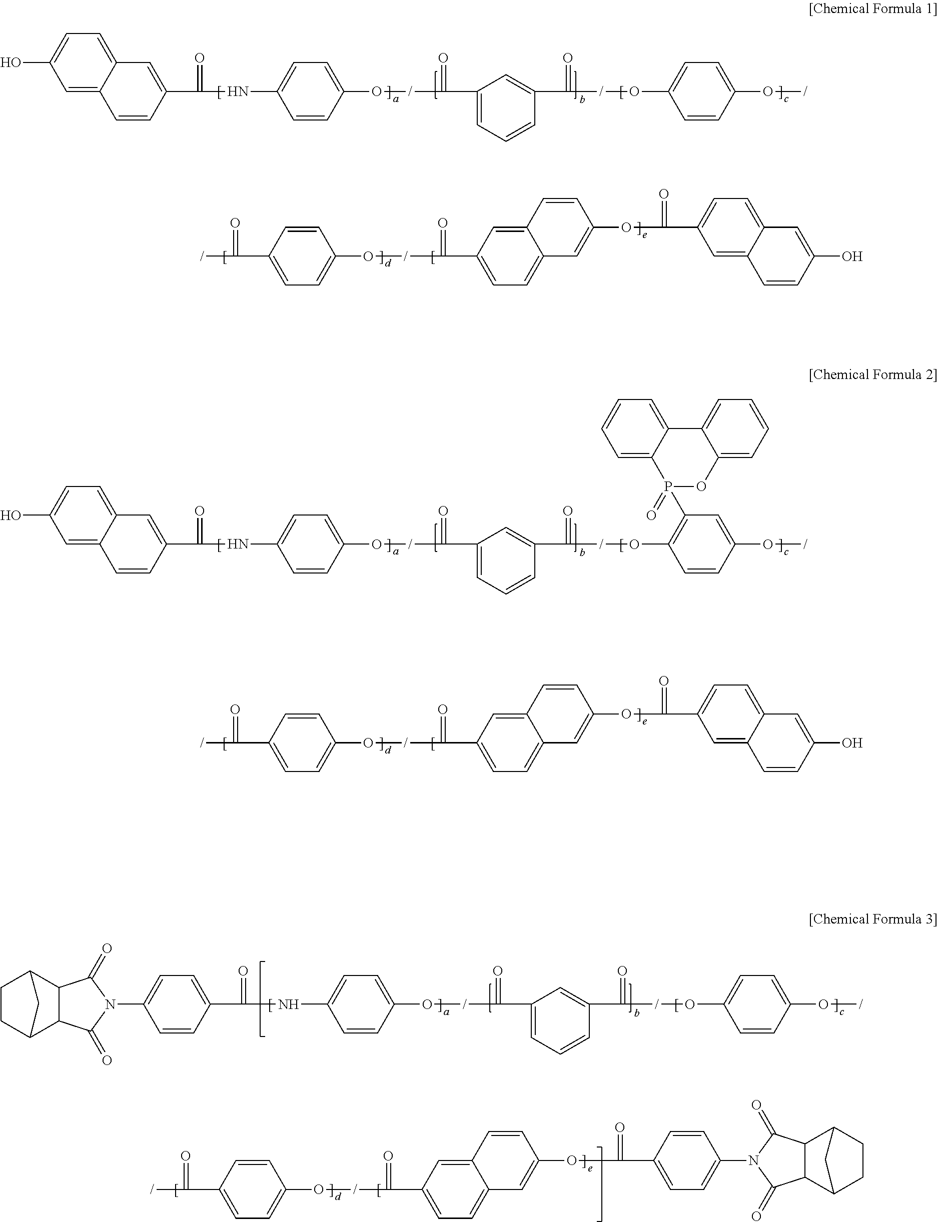

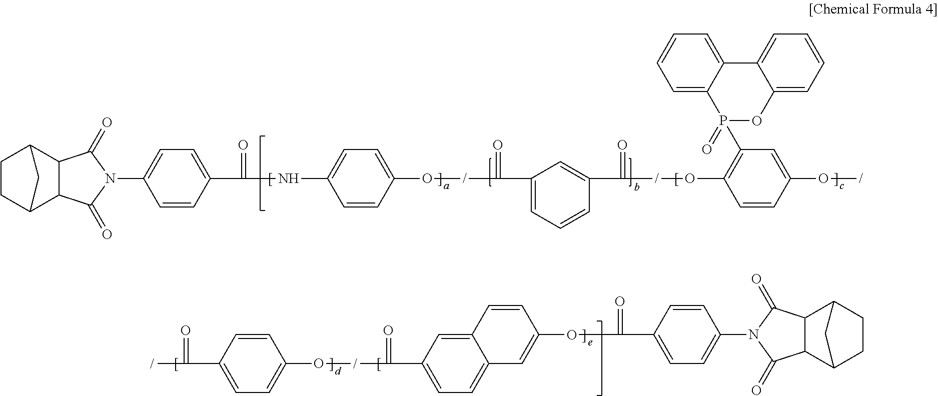

In Chemical Formulas 1 to 4, a is an integer of 13˜26, b is an integer of 13˜26, c is an integer of 9˜21, d is an integer of 10˜30, and e is an integer of 10˜30.

The liquid crystal oligomer represented by Chemical Formula 1 or 2 or the soluble liquid crystal thermosetting oligomer represented by Chemical Formula 3 or 4 includes ester groups at both ends of a backbone and a naphthalene group for crystallization, to improve dissipation factor and dielectric constant, and may contain a phosphorous component giving flame retardancy, as shown in Chemical Formula 2 or 4 above. Specifically, the liquid crystal oligomer or the soluble liquid crystal thermosetting oligomer includes a hydroxy group or a nadimide group at an end thereof, thereby allowing a thermosetting reaction with epoxy or bismaleimide, and also may react with a hydroxy group of chitin added. The oligomer includes an amide group giving solubility and a naphthalene group giving liquid crystallinity, and the compound represented by Chemical Formula 2 or 4 may contain a phosphorous component to realize flame retardancy. The amide group may react with the hydroxy group of the added chitin. In the chemical formulas, a, b, c, d and e each mean a molar ratio of the repetitive unit, and are determined depending on the contents of the start materials.

The liquid crystal oligomer has a number average molecular weight of, preferably 2,500 to 6,500 g/mol, more preferably 3,000 to 6,000 g/mol, and more preferably 3,000 to 5,000 g/mol. If the number average molecular weight thereof is below 2,500 g/mol, mechanical properties may be deteriorated. If the number average molecular weight thereof is above 6,500 g/mol, solubility may be decreased.

The amount of liquid crystal oligomer used is preferably 5 to 60 wt. %, and more preferably 15 to 40 wt. %. If the use amount thereof is below 5 wt. %, reduction in coefficient of thermal expansion and improvement in glass transition temperature may be slight. If the use amount thereof is above 60 wt. %, mechanical properties may be deteriorated.

Epoxy Resin

The epoxy resin composition according to the present invention may include an epoxy resin in order to improve handling property of the resin composition as an adhering film after drying. The epoxy resin means a material that contains, but is not particularly limited to, at least one epoxy group in a molecule thereof, and preferably at least two epoxy groups in a molecule thereof, and more preferably at least four epoxy groups in a molecule thereof.

Preferably, the epoxy resin used in the present invention may include a naphthalene group as shown in Chemical Formula 5 below, or may be an aromatic amine type as shown in Chemical Formula 6.

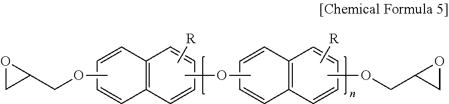

In Chemical Formula 5, R is C1˜C20 alkyl, and n is an integer of 0˜20.

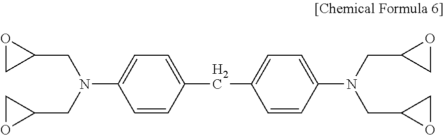 [SMILES: c1cc(N(CC2CO2)CC2CO2)ccc1Cc1ccc(N(CC2CO2)CC2CO2)cc1]

However, the epoxy resin used in the present invention is not particularly limited to an epoxy resin represented by Chemical Formula 5 or 6 above, and examples thereof may include a bisphenol A type epoxy resin, a bisphenol F type epoxy resin, a bisphenol S type epoxy resin, a phenol novolac type epoxy resin, an alkyl phenol novolac type epoxy resin, a cresol novolac type epoxy resin, a biphenyl type epoxy resin, an aralkyl type epoxy resin, a cyclopentadiene type epoxy resin, a naphthalene type epoxy resin, a naphthol type epoxy resin, an epoxy resin of condensate of phenol and aromatic aldehyde having a phenolic hydroxy group, a biphenyl aralkyl type epoxy resin, a fluorene type epoxy resin, a Xanthene type epoxy resin, a triglycidyl isocianurate, a rubber modified epoxy resin, a phosphorous based epoxy resin, and the like. One kind or two or more kinds of epoxy resins may be used in a mixture. Preferably, at least one selected from the naphthalene based epoxy resin, the bisphenol A type epoxy resin, the phenol novolac epoxy resin, the cresol novolac epoxy resin, the rubber modified epoxy resin, and the phosphorous based epoxy resin may be selected.

The use amount of epoxy resin is preferable 5 to 50 wt. %. If the use amount thereof is below 5 wt. %, handling property may be deteriorated. If the use amount thereof is above 50 wt. %, the added amount of other components is relatively small, and thus, the dissipation factor, dielectric constant, and coefficient of thermal expansion of the resin composition may be less improved.

Inorganic Filler

The epoxy resin composition according to the preset invention includes an inorganic filler in order to lower the coefficient of thermal expansion (CTE) of the epoxy resin. The inorganic filler lowers the coefficient of thermal expansion, and the content ratio thereof in the epoxy resin composition is different depending on the requested characteristics in consideration of the use of the epoxy resin composition, but is preferably 30 to 80 wt. %. If the content ratio thereof is below 30 wt. %, the dissipation factor may be lowered and the coefficient of thermal expansion may be increased. If the content ratio thereof is above 80 wt. %, adhering strength may be deteriorated.

Specific examples of the inorganic filler used in the present invention may include at least one alone or two or more in combination, selected from silica, alumina, barium sulfate, talc, mud, a mica powder, aluminum hydroxide, magnesium hydroxide, calcium carbonate, magnesium carbonate, magnesium oxide, boron nitride, aluminum borate, barium titanate, calcium titanate, magnesium titanate, bismuth titanate, titan oxide, barium zirconate, calcium zirconate, and the like. Particularly, preferable is silica having a low dielectric dissipation factor.

In addition, the inorganic filler may be used by being dispersed in a size of several nanometers to several tens of micrometers, or by being mixed without dispersion. If the inorganic filler has an average particle size of 10 μm or larger, it is difficult to stably form fine patterns when a circuit pattern is formed in a conductor layer. Hence, the average particle size of the inorganic filler is preferably 10 μm or smaller. In addition, the inorganic filler is preferably surface-treated with a surface treating agent such as a silane coupling agent, in order to improve moisture resistance. More preferable is silica having a diameter of 0.008 to 5 μm.

Hardener

Meanwhile, in the present invention, a hardener may be optionally used. Any one that can be generally used in order to thermally harden an epoxy resin may be used, but is not particularly limited thereto.

Specific examples of the hardener may include amide based hardeners such as dicyandiamide and the like; polyamine based hardeners such as diethylene triamine, triethylene tetraamine, N-aminoethyl piperazine, diaminodiphenyl methane, adipic acid dihydrazide and the like; acid anhydride hardeners such as pyrometallic acid anhydride, benzophenone tetracarboxylic acid anhydride, ethylene glycol bis trimetallic acid anhydride, glycerol tris trimetallic acid anhydride, maleic methyl cyclohexene tetracarboxylic acid anhydride and the like; phenol novolac type hardeners; polymercaptan hardeners such as trioxane triethylene mercaptan and the like; tertiary amine hardeners such as benzyl dimethyl amine, 2,4,6-tris(dimethylaminomethyl)phenol, and the like; and imidazole hardeners such as 2-ethyl-4-methyl imidazole, 2-methyl-imidazole, 1-benzyl-2-methyl imidazole, 2-heptadecyl imidazole, 2-undecyl imidazole, 2-phenyl-4-methyl-5-hydroxymethyl imidazole, 2-phenyl imidazole, 2-phenyl-4-methyl imidazole, 1-benzyl-2-phenyl imidazole, 1,2-dimethyl-imidazole, 1-cyanoethyl-2-phenyl imidazole, 2-phenyl-4,5-dihydroxymethyl imidazole, and the like. One or two or more hardeners may be used in a mixture as the hardener of the present invention. Particularly, preferable is dicyandiamide in view of physical properties. The use amount of hardener may be appropriately selected in consideration of the hardening rate without deteriorating inherent physical properties of the epoxy resin, in the range known to those skilled in the art, for example, in the range of 0.1 to 1 part by weight based on 100 parts by weight of a mixture of the liquid crystal oligomer and the epoxy resin.

Hardening Accelerator

In addition, the epoxy resin composition of the present invention can efficiently harden the epoxy resin of the present invention by optionally including a hardening accelerator. Examples of the hardening accelerator used in the present invention may include metal based hardening accelerators, imidazole based hardening accelerators, amine based hardening accelerators, and the like, and one or two or more in combination thereof may be used in a general amount used in the art.

Examples of the metal based hardening accelerator may include, but are not particularly limited to, organometal complexes of metals, such as, cobalt, copper, zinc, iron, nickel, manganese, tin, or the like, and organometal salts. Specific examples of the organometal complex may include organocobalt complexes such as cobalt (II) acetylacetonate, cobalt (III) acetylacetonate, and the like; organocopper complexes such as copper (II) acetylacetonate and the like; organozinc complexes such as zinc (II) acetylacetonate and the like; organoiron complexes such as iron (III) acetylacetonate and the like; organonickel complexes such as nickel (II) acetylacetonate and the like; organomanganese complexes such as manganese (II) acetylacetonate and the like; and the like. Examples of the organometal salt may include zinc octylate, tin octylate, zinc naphthenate, cobalt naphthenate, tin stearate, zinc stearate, and the like. As the metal based hardening accelerator, in view of hardening property and solvent solubility, cobalt (II) acetylacetonate, cobalt (III) acetylacetonate, (II) zinc acetylacetonate, zinc naphthenate, and iron (III) acetylacetonate are preferable, and cobalt (II) acetylacetonate and zinc naphthenate are more preferable. One or two or more in combination of the metal based hardening accelerators may be used.

Examples of the imidazole based hardening accelerator may include, but are not particularly limited to, imidazole compounds, such as, 2-methyl imidazole, 2-undecyl imidazol, 2-heptadecyl imidazole, 1,2-dimethyl imidazole, 2-ethyl-4-methyl imidazole, 1,2-dimethyl imidazole, 2-ethyl-4-methyl imidazole, 2-phenyl imidazole, 2-phenyl-4-methyl imidazole, 1-benzyl-2-methyl imidazole, 1-benzyl-2-phenyl imidazole, 1-cyanoethyl-2-methyl imidazole, 1-cyanoethyl-2-undecyl imidazole, 1-cyanoethyl-2-ethyl-4-methyl imidazole, 1-cyanoethyl-2-phenyl imidazole, 1-cyanoethyl-2-undencyl imidazolium trimellitate, 1-cyanoethyl-2-phenyl imidazolium trimellitate, 2,4-diamino-6-[2′-methyl imidazolyl-(1′)]-ethyl-s-triazine, 2,4-diamino-6-[2′-undecyl imidazolyl-(1′)]-ethyl-s-triazine, 2,4-diamin-6-[2′-ethyl-4′-methyl imidazolyl-(1′)]-ethyl-s-triazine, 2,4-diamino-6-[2′-methyl imidazolyl-(1′)]-ethyl-s-triazine isocyanuric acid adduct, 2-phenyl imidazole isocyanuric acid adduct, 2-phenyl-4,5-dihydroxymethyl imidazole, 2-phenyl-4-methyl-5-hydroxy methyl imidazole, 2,3-dihydroxy-1H-pyrrolo[1,2-a]benz imidazole, 1-dodecyl-2-methyl-3-benzyl imidazolium chloride, 2-methyl imidazolin, 2-phenyl imidazolin, and the like; and adduct bodies of the imidazole compounds and the epoxy resin. One or two or more in combination of the imidazole hardening accelerators may be used.

Examples of the amine based hardening accelerators may include, but are not particularly limited to, amine compounds, for example, trialkyl amines such as trimethylamine, tributylamine, and the like, 4-dimethylaminopyridine, benzyldimethyl amine, 2,4,6-tris(dimethylaminomethyl)phenol, 1,8-diazabicyclo(5,4,0)-undecene (hereinafter, referred to as DBU), and the like. One or two or more in combination of the amine based hardening accelerators may be used.

Thermoplastic Resin

The epoxy resin composition of the present invention may optionally include a thermoplastic resin in order to improve film formability of the resin composition or improve mechanical property of the hardened material. Examples of the thermoplastic resin may include a phenoxy resin, a polyimide resin, a polyamideimide (PAI) resin, a polyetherimide (PEI) resin, a polysulfone (PS) resin, a polyethersulfone (PES) resin, a polyphenyleneether (PPE) resin, a polycarbonate (PC) resin, a polyetheretherketone (PEEK) resin, a polyester resin, and the like. These thermoplastic resins may be used alone or in a mixture of two or more thereof. The average weight molecular weight of the thermoplastic resin is preferably in a range of 5,000 to 200,000. If the average weight molecular weight of the thermoplastic resin is below 5,000, improving effects in film formability and mechanical strength may not be sufficiently exhibited. If the average weight molecular weight thereof is above 200,000, compatibility with the chitin, the liquid crystal oligomer, and the epoxy resin may not be sufficient; the surface unevenness after hardening may become larger; and high-density fine patterns may be difficult to form.

In the case where a thermoplastic resin is blended with the epoxy resin composition of the present invention, the content of thermoplastic resin in the resin composition is, but is not particularly limited to, preferably 0.1 to 10 wt. %, and more preferably 1 to 5 wt. %, based on 100 wt. % of non-volatile components in the resin composition. If the content of thermoplastic resin is below 0.1 wt. %, improving effects of film formability or mechanical strength may not be exhibited. If the content thereof is above 10 wt. %, molten viscosity may be increased and surface roughness of an insulating layer after a wet roughening process may be increased.

The epoxy resin composition according to the present invention is mixed in the presence of an organic solvent. Examples of the organic solvent, in consideration of solubility and miscibility of the resin and other additives used in the present invention, may include dimethyl formamide, dimethyl acetamide, 2-methoxy ethanol, acetone, methyl ethyl ketone, cyclohexanone, ethyl acetate, butyl acetate, cellosolve acetate, propylene glycol monomethyl ether acetate, ethylene glycol monobutyl ether acetate, cellosolve, butyl cellosolve, carbitol, butyl carbitol, and xylene, but are not particularly limited thereto.

Viscosity of the epoxy resin composition according to the present invention is preferably 700 to 1500 cps, which is appropriate for the manufacture of the insulating film and achieves proper sticking property at room temperature. The viscosity of the epoxy resin composition of the present invention may be controlled by varying the content of the solvent (for example, DMAc or the like). Other non-volatile components excluding the solvent count for 30 to 70 wt. % of the epoxy resin composition. If the viscosity of the epoxy resin composition is out of the above range, it may be difficult to form an insulating film, or there may be in molding difficulty even though the insulating film is formed.

In addition, peeling strength shows 1.0 kN/m in an insulating film state when copper foil of 12 μm is used. The insulating film manufactured by using the epoxy resin according to the present invention has a coefficient of thermal expansion (CTE) of below 25 ppm/° C. measured in a temperature range of 50˜150° C., and a coefficient of thermal expansion (CTE) of below 80 ppm/° C. measured at the glass transition temperature or higher. In addition, the insulating film has tensile modulus of 11 or higher, a glass transition temperature (Tg) of 210 to 300 t, and more preferably 230 to 270° C.

Besides, the present invention may further include, as necessary, other known leveling agents and/or flame retardants by those skilled in the art within the technical scope of the present invention.

The epoxy resin composition of the present invention may be manufactured into a semisolid phase dry film by any general method known in the art. For example, a film may be manufactured by using a roll coater, a curtain coater, or the like, and then dried. Then, the film is applied onto a substrate, to thereby be used as an insulating layer (or an insulating film) or a prepreg when the multilayer printed circuit board is manufactured in a build-up manner. This insulating film or the prepreg has a low coefficient of thermal expansion (CTE) of 25 ppm/° C. or lower.

As such, a substrate such as glass fiber or the like is impregnated with the epoxy resin composition according to the present invention, and hardened, to thereby manufacture a prepreg. A copper foil is laminated on the prepreg, to thereby obtain a copper clad laminate (CCL) as shown in FIG. 1. In addition, the insulating film manufactured from the epoxy resin composition according to the present invention may be used in the manufacture of the multilayer printed circuit board as shown in FIG. 2, by being laminated on the CCL, which is used as an inner layer at the time of manufacturing the multilayer printed circuit board. For example, the multilayer printed circuit board may be manufactured by laminating the insulating film formed of the epoxy resin composition on a patterned inner layer circuit board; hardening it at a temperature of 80 to 110° C. for 20 to 30 minutes; performing a desmear process; and then forming a circuit layer through an electroplating process.

Hereinafter, the present invention will be described in more detail with reference to the following examples and comparative examples, but the scope of the present invention is not limited thereto.

### Preparative Example

### Preparation of Liquid Crystal Oligomer

In a 20 L-glass reactor, 4-aminophenol 218.26 g (2.0 mol), isophthalic acid 415.33 g (2.5 mol), 4-hydroxy benzoic acid 276.24 g (2.0 mol), 6-hydroxy-2-naphthoic acid 282.27 g (1.5 mol), 9,10-dihydroxy-9-oxa-10-phosphaphenanthrene-10-oxide (DOPO) 648.54 g (2.0 mol), and acetic acid anhydride 1531.35 g (15.0 mol) were added. After an inside of the reactor was sufficiently replaced with nitrogen gas, the temperature in the reactor was raised to a temperature of 230° C. under flow of the nitrogen gas, and then refluxing was carried out for 4 hours while this temperature in the reactor was maintained. After further addition of 6-hydroxy-2-naphthoic acid 188.18 g (1.0 mol) for end capping, acetic acid which is reaction byproduct and unreacted acetic acid anhydride were removed, thereby preparing a liquid crystal oligomer represented by Chemical Formula 2 having a molecular weight of about 4500.

### Example 1

### Preparation of Varnish Employing Chitin Nanoparticle and Manufacture of Film

50 g of the liquid crystal oligomer containing a hydroxy group, prepared in Preparative Example 1, and 8.3 g of a chitin nanoparticle were added to 50 g of N,N′-dimethylacetamide (DMAc), to prepare a liquid crystal oligomer solution containing chitin. 107.09 g of silica filler slurry (silica content: 78.13 wt. %) was added thereto, followed by stirring for 30 minutes. 25 g of Araldite MY-721 (Huntsmann Company) as an epoxy resin and 0.33 g of dicyandiamide as a hardener were further added thereto, followed by stirring for 2 hours. This was coated on a shiny surface of copper foil to have a thickness of 100 μm by a doctor blade method, thereby manufacturing a film. The film was dried at room temperature for 2 hours, dried in a vacuum oven at 80° C. for 1 hour, and then again dried at 110° C. for 1 hour, to thereby become in a B-stage. This was completely hardened by using vacuum press. Here, the maximum temperature was 230° C. and the maximum pressure was 2 MPa.

### Example 2

### Preparation of Varnish Employing Chitin Nanofiber and Manufacture of Film

50 g of the liquid crystal oligomer containing a hydroxy group, prepared in Preparative Example 1, and 8.3 g of a chitin nanofiber were added to 50 g of N,N′-dimethylacetamide (DMAc), to prepare a liquid crystal oligomer solution. 107.09 g of silica filler slurry (silica content: 78.13 wt. %) was added thereto, followed by stirring for 30 minutes. 25 g of Araldite MY-721 (Huntsmann Company) as an epoxy resin and 0.33 g of dicyandiamide as a hardener were further added thereto, followed by stirring for 2 hours. This was coated on a shiny surface of copper foil to have a thickness of 100 μm by a doctor blade method, thereby manufacturing a film. The film was dried at room temperature for 2 hours, dried in a vacuum oven at 80° C. for 1 hour, and then again dried at 110° C. for 1 hour, to thereby become in a B-stage. This was completely hardened by using vacuum press. Here, the maximum temperature was 230° C. and the maximum pressure was 2 MPa.

### Comparative Example 1

### Preparation of Varnish Including Liquid Crystal Oligomer and Manufacture of Film

50 g of the liquid crystal oligomer containing a hydroxy group, prepared in Preparative Example 1, was added to 50 g of N,N′-dimethylacetamide (DMAc), to prepare a liquid crystal oligomer solution. 107.09 g of silica filler slurry (silica content: 78.13 wt. %) was added thereto, followed by stirring for 30 minutes. 25 g of Araldite MY-721 (Huntsmann Company) as an epoxy resin and 0.33 g of dicyandiamide as a hardener were further added thereto, followed by stirring for 2 hours. This was coated on a shiny surface of copper foil to have a thickness of 100 μm by a doctor blade method, thereby manufacturing a film. The film was dried at room temperature for 2 hours, dried in a vacuum oven at 80° C. for 1 hour, and then again dried at 110° C. for 1 hour, to thereby become in a B-stage. This was completely hardened by using vacuum press. Here, the maximum temperature was 230° C. and the maximum pressure was 2 MPa.

Evaluation on Thermal Property

With respect to each sample of the insulating films manufactured by the examples and comparative example, coefficients of thermal expansion (CTE) thereof was at a temperature range of 50˜150° C. (a1) and at the glass transition temperature or higher (a2), by using a thermo mechanical analyzer (TMA). The glass transition temperature (Tg) was measured by differential scanning calorimeter (DSC) while the temperature was raised up to 270° C. (first cycle) and 300° C. (second cycle) at a rate of 10° C./min in the nitrogen ambience by using a heat analyzer (TMA 2940, TA instruments). Tensile modulus was measured by dynamic mechanical analysis (DMA). The measurement results were tabulated in Table 1.

TABLE 1

| | | | Comparative |
|---|---|---|---|
| Classification | Example 1 | Example 2 | Example 1 |
| CTE (a1, ppm/° C.) | 23 | 24 | 35 |
| CTE (a2, ppm/° C.) | 75 | 76 | 88 |
| Tensile Modulus (GPa) | 11.5 | 12.8 | 9.1 |
| Glass Transition | 230 | 230 | 200 |
| Temperature (Tg) | | | |

As can be seen from Table 1 above, the insulating film manufactured by using the epoxy resin composition according to the present invention had relatively low coefficient of thermal expansion, high tensile modulus, and high glass transition temperature (Tg) as compared with the film of Comparative Example 1.

As set forth above, the epoxy resin composition for insulation, the insulating film and the prepreg manufactured by using the same, according to the present invention, can have a low coefficient of thermal expansion, a high glass transition temperature, high rigidity, high heat resistance, and high mechanical strength, and secure processability enough to form low roughness for forming fine circuit patterns while fundamentally securing low dielectric constant and moisture absorption.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An epoxy resin composition for insulation, the epoxy resin composition comprising:
a chitin nanoparticle or a chitin nanofiber;
a liquid crystal oligomer or a soluble liquid crystal thermosetting oligomer;
an epoxy resin; and
an inorganic filler.

2. The epoxy resin composition as set forth in claim 1, wherein the liquid crystal oligomer or the soluble liquid crystal thermosetting oligomer is represented by Chemical Formula 1, 2, 3, or 4, below: 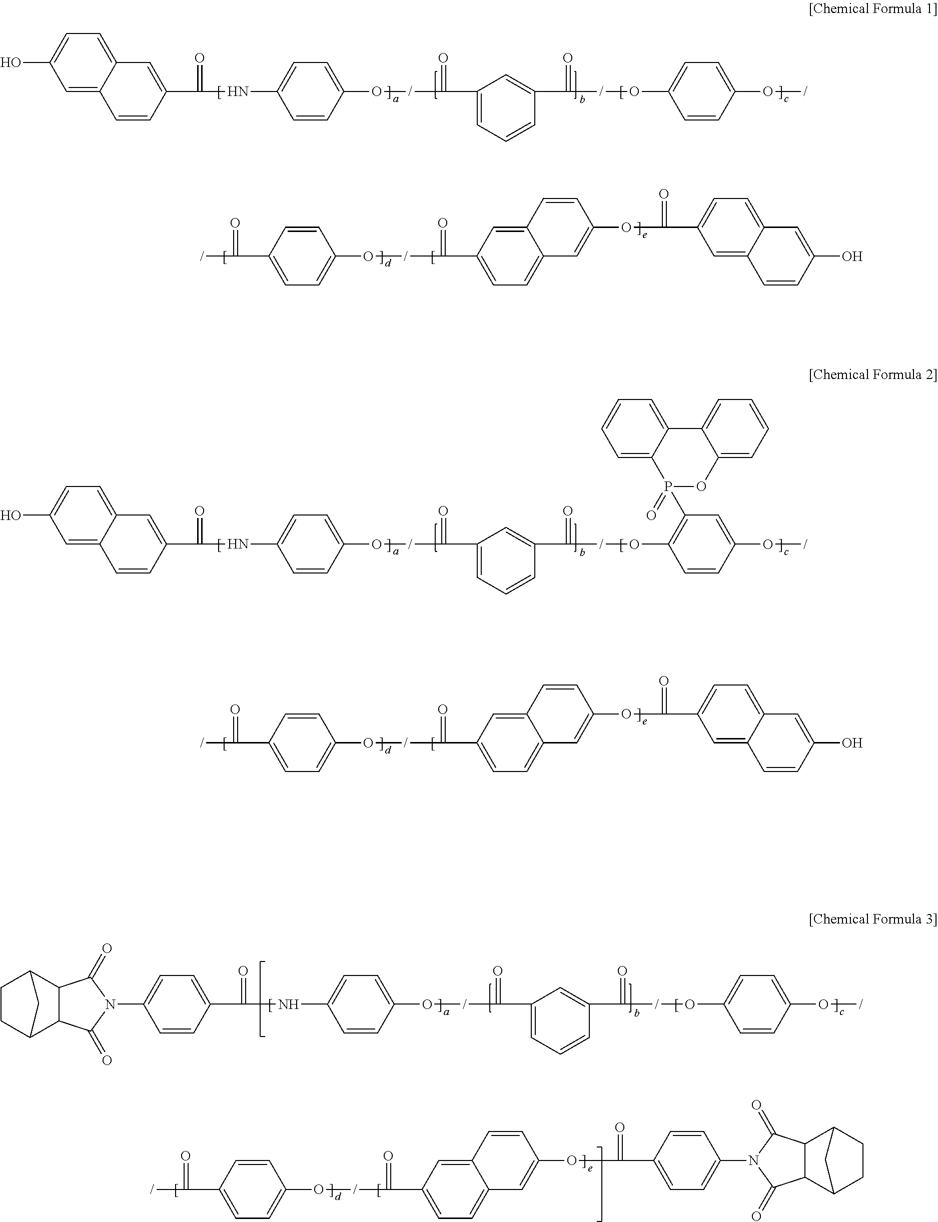 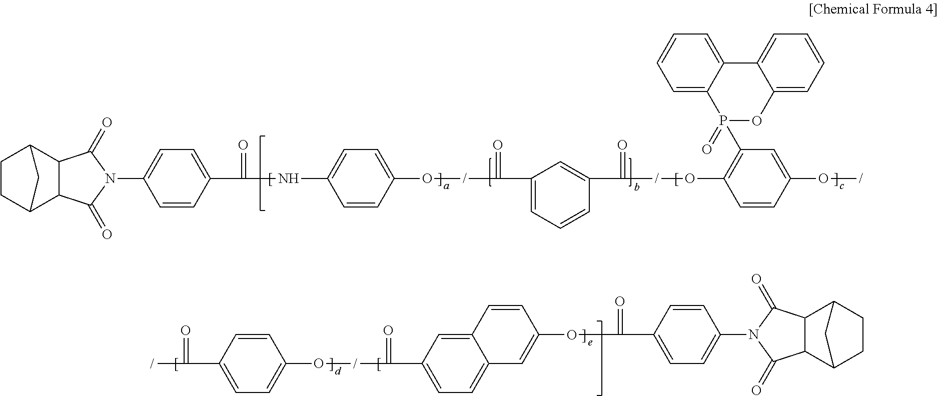
wherein in Chemical Formulas 1 to 4, a is an integer of 13˜26, b is an integer of 13˜26, c is an integer of 9-21, d is an integer of 10˜30, and e is an integer of 10˜30.

3. The epoxy resin composition as set forth in claim 1, wherein the epoxy resin is represented by Chemical Formula 5 or 6: 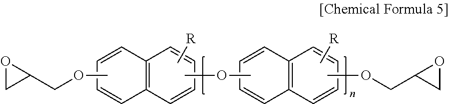
wherein in Chemical Formula 5, R is C1˜C20 alkyl, and n is an integer of 0˜20,

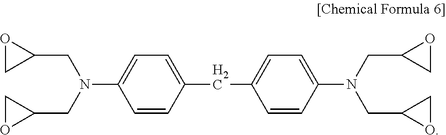 [SMILES: c1cc(N(CC2CO2)CC2CO2)ccc1Cc1ccc(N(CC2CO2)CC2CO2)cc1]

4. The epoxy resin composition as set forth in claim 1, wherein it contains 0.5 to 30 wt. % of the chitin nanoparticle or the chitin nanofiber, 5 to 60 wt. % of the liquid crystal oligomer, 5 to 50 wt. % of the epoxy resin, and 30 to 80 wt. % of the inorganic filler.

5. The epoxy resin composition as set forth in claim 1, wherein the liquid crystal oligomer or the soluble liquid crystal thermosetting oligomer has a number average molecular weight of 2,500 to 6,500.

6. The epoxy resin composition as set forth in claim 1, further comprising at least one epoxy resin selected from a naphthalene based epoxy resin, a bisphenol A type epoxy resin, a phenol novolac epoxy resin, a cresole novolac epoxy resin, a rubber modified epoxy resin, and a phosphorous based epoxy resin.

7. The epoxy resin composition as set forth in claim 1, further comprising at least one hardener selected from amide based hardeners, polyamine based hardeners, acid anhydride hardeners, phenol novolac type hardeners, polymercaptan hardeners, tertiary amine hardeners, and imidazole hardeners.

8. The epoxy resin composition as set forth in claim 1, wherein the inorganic filler is at least one selected from the group consisting of silica, alumina, barium sulfate, talc, mud, a mica powder, aluminum hydroxide, magnesium hydroxide, calcium carbonate, magnesium carbonate, magnesium oxide, boron nitride, aluminum borate, barium titanate, calcium titanate, magnesium titanate, bismuth titanate, titan oxide, barium zirconate, and calcium zirconate.

9. The epoxy resin composition as set forth in claim 1, wherein the inorganic filler has a diameter of 0.008 to 10 μm.

10. The epoxy resin composition as set forth in claim 1, further comprising at least one hardening accelerator selected from metal based hardening accelerators, imidazole based hardening accelerators, and amine based hardening accelerators.

11. The epoxy resin composition as set forth in claim 1, further comprising at least one thermoplastic resin selected from a phenoxy resin, a polyimide resin, a polyamideimide (PAI) resin, a polyetherimide (PEI) resin, a polysulfone (PS) resin, a polyethersulfone (PES) resin, a polyphenyleneether (PPE) resin, a polycarbonate (PC) resin, a polyetheretherketone (PEEK) resin, and a polyester resin.

12. An insulating film manufactured by using the epoxy resin composition as set forth in claim 1.

13. A prepreg manufactured by impregnating a substrate with the epoxy resin composition as set forth in claim 1.

14. A printed circuit board comprising the insulating film as set forth in claim 12.

15. A printed circuit board comprising the prepreg as set forth in claim 13.
